(19) United States
(12) Patent Application Publication
(10) Pub. No.: US 2023/0025826 A1
(43) Pub. Date: Jan. 26, 2023

(54) Anomaly Detection Using Graph Neural Networks

(71) Applicant: ServiceNow, Inc., Santa Clara, CA (US)

(72) Inventors: Perouz Taslakian, Montreal (CA); David Vazquez, Montreal (CA); Pierre-André Noël, Montreal (CA); Benoit Sixte Corsini, Montreal (CA)

(21) Appl. No.: 17/373,046

(22) Filed: Jul. 12, 2021

(51) Int. Cl. G06N 3/08; G06N 3/04

(52) U.S. Cl. CPC G06N 3/08; G06N 3/0454

(57) ABSTRACT

Persistent storage contains configuration items representing computing hardware and software, wherein each configuration item is respectively associated with a set of attributes, and wherein pairwise relationships are defined between some of the configuration items. One or more processors are configured to: select a subset of the configuration items that are connected by way of a subset of the pairwise relationships; form a graph representation in which the subset of the configuration items is represented as nodes and the subset of the pairwise relationships is represented as edges between pairs of the nodes; train a graph neural network with k layers on the graph representation, wherein training the graph neural network involves sequentially generating k embeddings for the sets of attributes associated with the nodes, wherein the embeddings are in an f-dimensional feature space; and based a kth of the embeddings, determine that a particular node of the nodes is anomalous.

### BACKGROUND

Modern computing systems can be complex entities with numerous devices disposed within one or more networks, with each device operating a set of software applications. These software applications may interact with one another, across the network(s), in order to carry out higher-level services. For example, a web infrastructure may include load balancers, web server nodes, and database nodes, distributed in various arrangements, to provide web-based services.

These devices and software applications may be discovered and then represented in a configuration management database (CMDB) as configuration items with distinct sets of attributes. Pairwise or other types of relationships between configuration items may also be represented in the database. Such representations can be used to describe a service as a graph of configuration items (nodes) and relationships therebetween (edges). Once established, the graph can be used to visualize the service, as well as to debug problems experienced by users of the service and to determine the impact of changes made to any component of the service.

Nonetheless, given the volume and complexity of configuration item data for large networks, it is difficult to detect anomalies in this data. For example, an anomaly may present itself as an attribute of a node that has a value that is different from corresponding attributes of similarly-situated nodes, or as a node with a relationship to another node that exhibits an anomaly. Being able to identify such anomalies in a proactive fashion can improve the correctness, robustness, and security of networks and services.

### SUMMARY

The embodiments herein overcome these and potentially other problems through the use of graph neural networks (GNNs). Particularly, GNNs are used in self-supervised models that represent the attributes of configuration items (nodes) as vectors in a multi-dimensional feature space. To achieve such a representation, various attributes and/or features (i.e., elements in the associated vectors) are hidden or masked while one or more GNNs are trained to be able to use the available features to predict the features that cannot be observed. Since the values of the predicted features take into account the visible attributes of each node as well as those of its neighboring nodes, they are more useful in anomaly detection than just using the attributes in isolation. Then, various anomaly detection algorithms can be applied to the features as predicted. When doing so, experimental results establish that the aforementioned pre-training with GNNs produces more accurate results than the previous state of the art.

While the embodiments herein are focused on improving anomaly detection in CMDB data, they can be used with other types of data as well. Therefore, these embodiments are not intended to be limiting.

Accordingly, a first example embodiment may involve persistent storage containing configuration items representing computing hardware and software deployed in a network, wherein each of the configuration items is respectively associated with a set of attributes, and wherein pairwise relationships are defined between at least some of the configuration items. The first example embodiment may also involve one or more processors configured to: (i) select a subset of the configuration items that are connected by way of a subset of the pairwise relationships; (ii) form a graph representation in which the subset of the configuration items is represented as nodes and the subset of the pairwise relationships is represented as edges between pairs of the nodes; (iii) train a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding; (iv) based a kth of the embeddings, determine that a particular node of the nodes is anomalous; and (v) provide an indication that a particular configuration item represented by the particular node is anomalous.

A second example embodiment may involve obtaining, from persistent storage, configuration items representing computing hardware and software deployed in a network, wherein each of the configuration items is respectively associated with a set of attributes, and wherein pairwise relationships are defined between at least some of the configuration items. A second example embodiment may involve selecting a subset of the configuration items that are connected by way of a subset of the pairwise relationships. A second example embodiment may involve forming a graph representation in which the subset of the configuration items is represented as nodes and the subset of the pairwise relationships is represented as edges between pairs of the nodes. A second example embodiment may involve training a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding. A second example embodiment may involve, based a kth of the embeddings, determining that a particular node of the nodes is anomalous. A second example embodiment may involve providing an indication that a particular configuration item represented by the particular node is anomalous.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 is a graph representing components of a network service, in accordance with example embodiments.

FIG. 7A is a graph of nodes with attributes and embeddings, in accordance with example embodiments.

FIG. 7B is a graph of nodes with some hidden attributes and embeddings, in accordance with example embodiments.

FIG. 7C is a graph of nodes with some masked attributes and embeddings, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

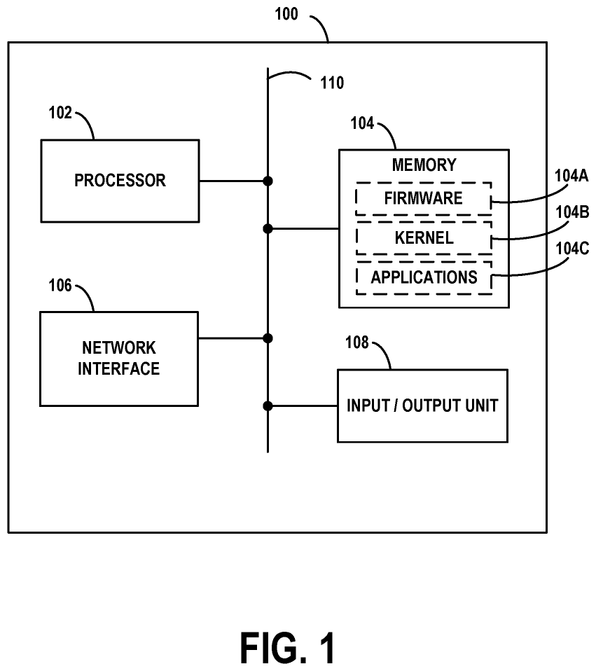

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

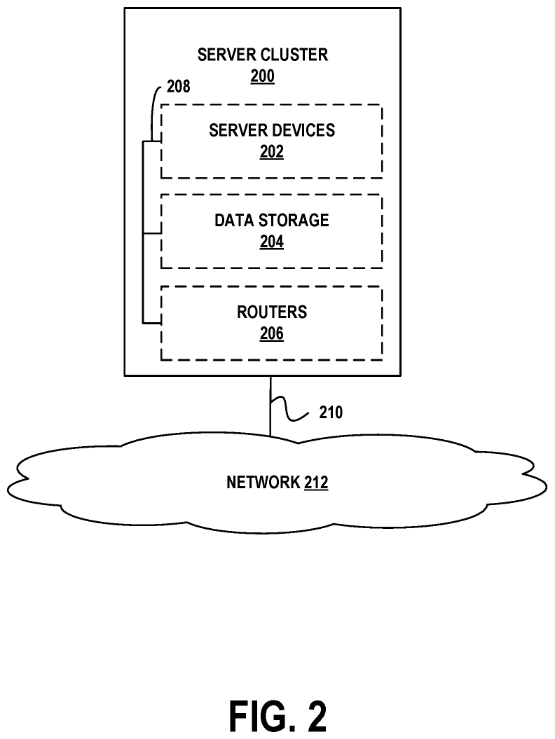

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

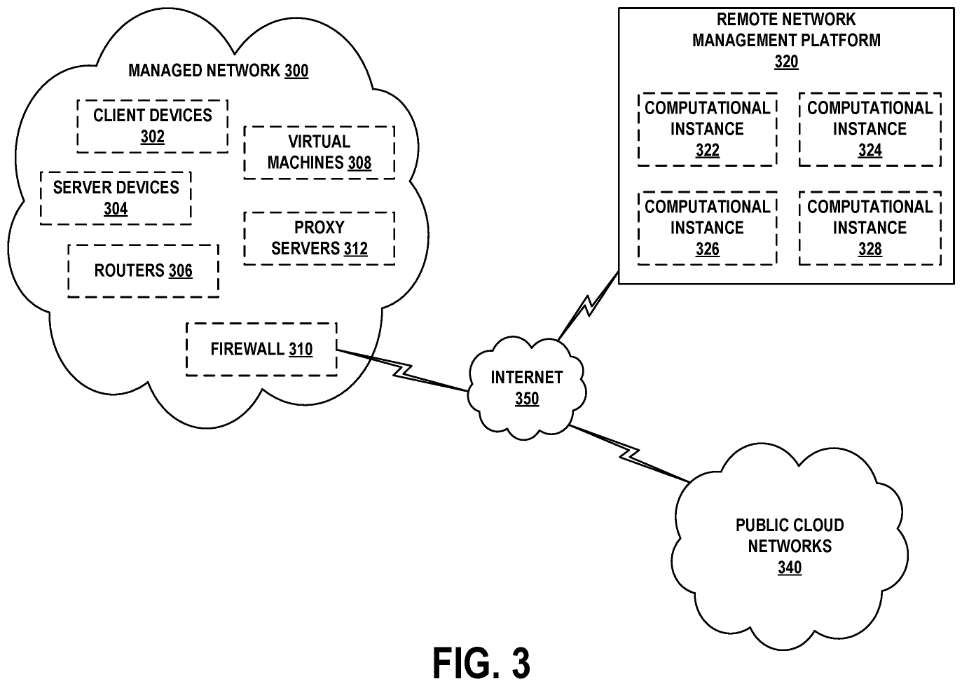

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

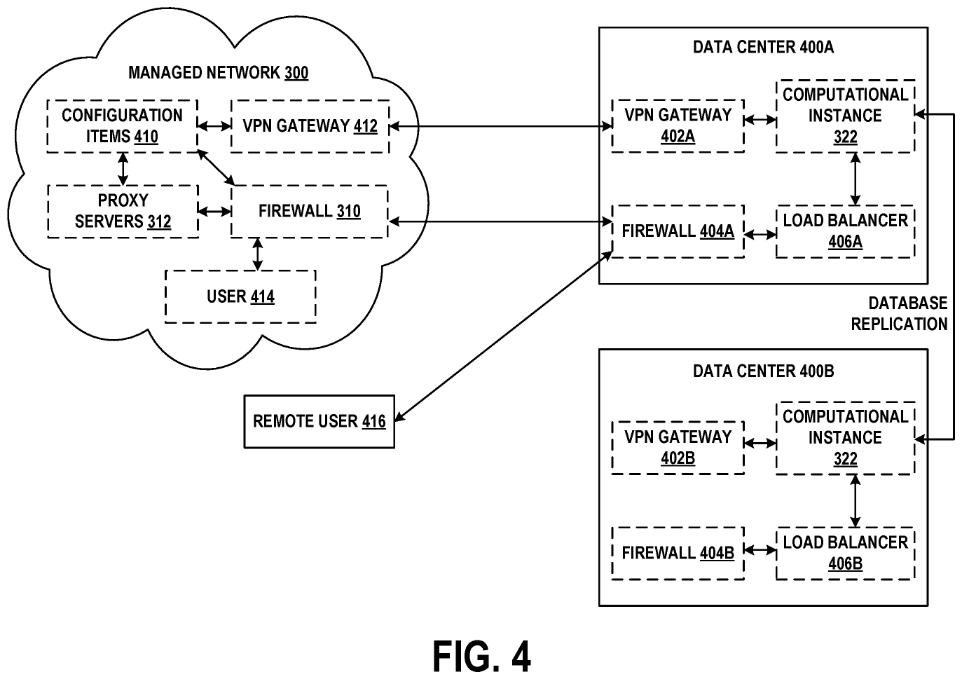

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

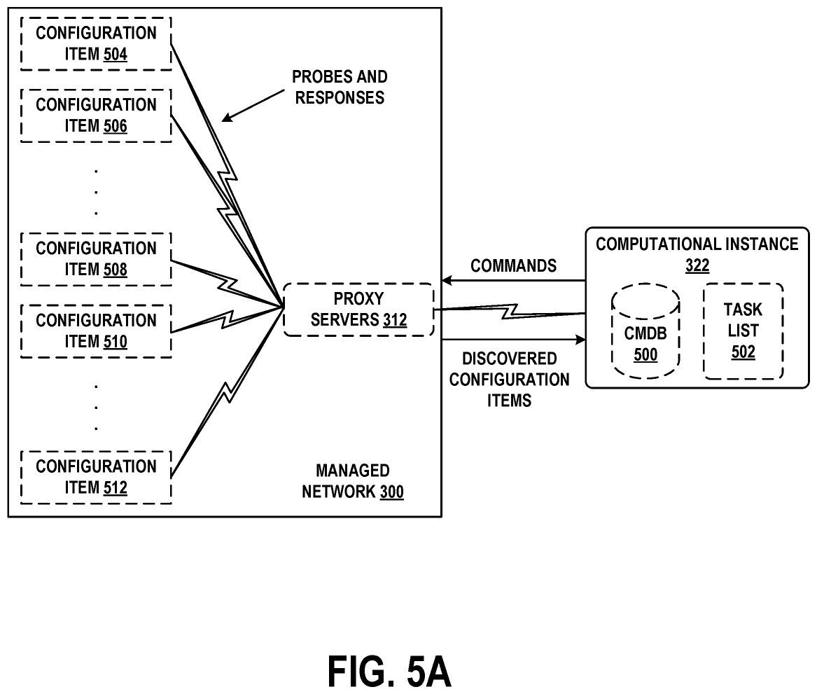

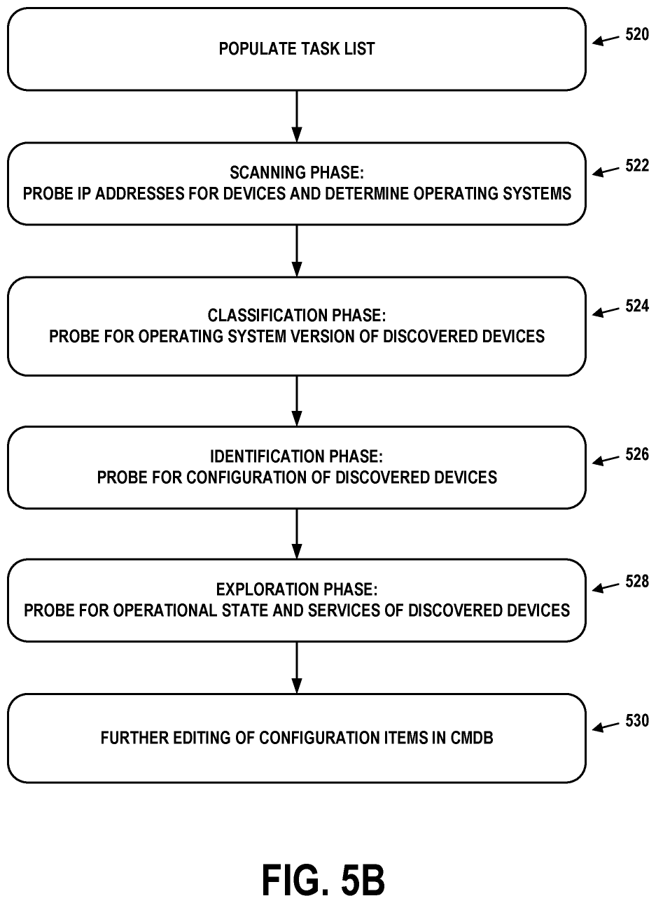

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. CMDB IDENTIFICATION RULES AND RECONCILIATION

A CMDB, such as CMDB 500, provides a repository of configuration items, and when properly provisioned, can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information related to configuration items in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API). This API may use a set of configurable identification rules that can be used to uniquely identify configuration items and determine whether and how they are written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to the identification and reconciliation API, the API may attempt to match the information with one or more rules. If a match is found, the configuration item is written to the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, the identification and reconciliation API will only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by reconciliation procedures or in another fashion. These configuration items may be flagged for manual de-duplication.

### VI. EXAMPLE NETWORK SERVICE AS A GRAPH

The discovery procedures described herein are particularly helpful in generating network maps. A network map may be a visual representation on a GUI, for instance, that depicts particular applications operating on particular devices as nodes in a graph. The edges of the graph may represent physical and/or logical network connectivity between these nodes. An instance of a network map may be derived from a portion of the data in a CMDB and tailored to represent the devices and applications that make up or contribute to the operation of a service.

Discovery procedures may be used to determine the physical or logical arrangement of devices on a managed network, as well as the applications operating on these devices. Discovery procedures may also determine the relationships between these devices and applications, such as those that define services. Alternatively or additionally, services may be manually defined after discovery has at least partially completed. From this information, a network map can be derived.

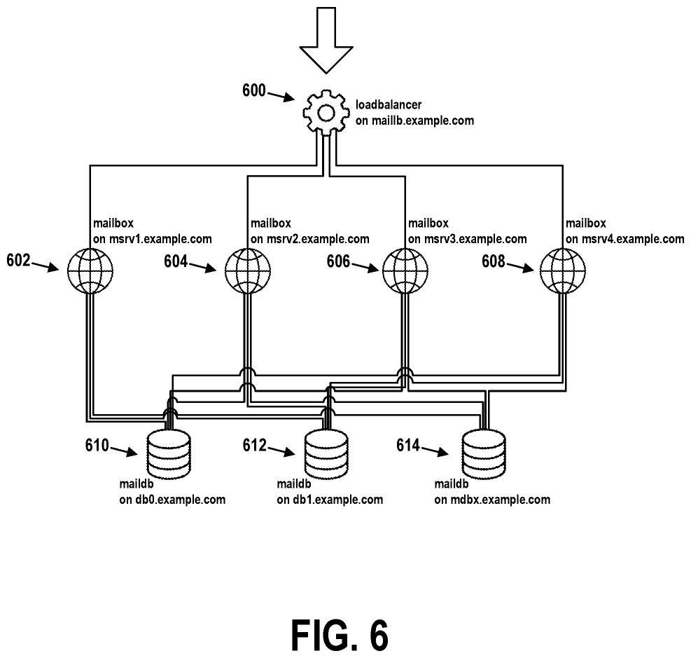

FIG. 6 provides an example graph of a network map including applications and devices that make up an email service that supports redundancy and high-availability. This graph may be generated for display on the screen of a computing device. As noted above, the nodes in the graph (i.e., nodes 600, 602, 604, 606, 608, 610, 612, and 614) represent applications operating on devices. Visually, these nodes may take the form of icons related to the respective functions of the applications or devices. The edges in the graph represent relationships between the nodes (e.g., “is hosted on”, “runs on”, “depends on”, or “used by”), though specific types of relationships are omitted from FIG. 6 to avoid clutter. For purposes of the internal graph representation and manipulation thereof, the visual depictions of nodes as icons and edges as lines is not relevant—other visual depictions may be used.

The entry point to the email service, as designated by the large downward-pointing arrow, may be load balancer 600 (“loadbalancer”). Load balancer 600 may be represented with a gear icon, and may operate on a device with host name maillb.example.com. This host name, as well as other host names herein, may be a partially-qualified or fully-qualified domain name in accordance with DNS domain syntax.

Load balancer 600 may distribute incoming requests across mailbox applications 602, 604, 606, and 608 (“mailbox”) operating on mail server devices msrv1.example.com, msrv2.example.com, msrv3.example.com, and msrv4.example.com, respectively. These mail server devices may be represented by globe icons on the graph. Connectivity between load balancer 600 and each of mailbox applications 602, 604, 606, and 608 is represented by respective edges.

Mailbox applications 602, 604, 606, and 608 may, for instance, respond to incoming requests for the contents of a user's mail folder, for the content of an individual email message, to move an email message from one folder to another, or to delete an email message. Mailbox applications 602, 604, 606, and 608 may also receive and process incoming emails for storage by the email service. Other email operations may be supported by mailbox applications 602, 604, 606, and 608. For sake of example, it may be assumed that mailbox applications 602, 604, 606, and 608 perform essentially identical operations, and any one of these applications may be used to respond to any particular request.

The actual contents of users' email accounts, including email messages, folder arrangements, and other settings, may be stored in one or more of mail database applications 610, 612, and 614 (“maildb”). These applications may operate on database server devices db0.example.com, db1.example.com, and mdbx.example.com, which are represented by database icons on the map and are also nodes in the underlying graph. Connectivity between mailbox applications 602, 604, 606, and 608 and each of mail database applications 610, 612, and 614 also is represented by respective edges.

Mailbox applications 602, 604, 606, and 608 may retrieve requested data from mail database applications 610, 612, and 614, and may also write data to mail database applications 610, 612, and 614. The data stored by mail database applications 610, 612, and 614 may be replicated across all of the database server devices.

As an example of the operation of the email service depicted by the graph of FIG. 6, an incoming email message may arrive at load balancer 600. This email message may be addressed to an email account (e.g., user@example.com) supported by the email service. Load balancer 600 may select one of mailbox applications 602, 604, 606, and 608 to store the email message. For instance, load balancer 600 may make this selection based on a round-robin procedure, the loads (e.g., CPU, memory, and/or network utilization) reported by mailbox applications 602, 604, 606, and 608, randomly, or some combination thereof.

Assuming that load balancer 600 selects mailbox application 604, load balancer 600 then transmits the email message to mailbox application 604. Mailbox application 604 may perform any necessary mail server functions to process the email message, such as verifying that the addressee is supported by the email server, validating the source of the email message, running the email message through a spam filter, and so on. After these procedures, mailbox application 604 may select one of mail database applications 610, 612, and 614 for storage of the email message. Similar to load balancer 600, mailbox application 604 may make this selection based on various criteria, including load on mail database applications 610, 612, and 614.

Assuming that mailbox application 604 selects mail database application 610, mailbox application 604 then transmits the email message to mail database application 610. Mail database application 610 may perform any necessary mail database functions to process and store the email message. For instance, mail database application 610 may store the message as a compressed file in a file system, and update one or more database tables to represent characteristics of the email message (e.g., the sender, the size of the message, its importance, where the file is stored, and so on).

When a mail client application (not shown) requests a copy of the email message, this request may also be received by load balancer 600. Load balancer 600 may select one of mailbox applications 602, 604, 606, and 608 to retrieve the email message. This selection may be made according to various criteria, such as any of those discussed above. Assuming that load balancer 600 selects mailbox application 608, mailbox application 608 then selects one of mail database applications 610, 612, and 614. Assuming that mailbox application 608 selects mail database application 612, mailbox application 608 requests the email message from mail database application 612.

Since data is replicated across mail database applications 610, 612, and 614, mail database application 612 is able to identify and retrieve the requested email message. For instance, mail database application 612 may look up the email message in a database table, from the table determine where the email message is stored in its file system, find the email message in the file system, and provide the email message to mailbox application 608. Mailbox application 608 may then transmit the email message to the mail client application.

The arrangement of the graph in FIG. 6 may vary. For example, more or fewer load balancers, mailbox applications, mail database applications, as well as their associated devices, may be present. Furthermore, additional devices may be included, such as storage devices, routers, switches, and so on. Additionally, while FIG. 6 is focused on an example email service, similar network graphs may be generated and displayed for other types of services, such as web services, remote access services, automatic backup services, content delivery services, and so on.

### VII. EXAMPLE NEURAL NETWORKS

While the embodiments herein focus on the use of graph neural networks with graph data (e.g., CMDB data), this section provides an illustrative overview of neural networks in general. Such an overview may be helpful in appreciating the improvements provided by these embodiments.

A neural network is a computational model in which a number of simple units, working individually in parallel and often without central control, combine to solve complex problems. While this model may resemble an animal's brain in some respects, analogies between neural networks and brains are tenuous at best. Modern neural networks have a fixed structure, a deterministic mathematical learning process, are usually trained to solve one problem at a time, and are much smaller than their biological counterparts.

A neural network is represented as a number of nodes that are arranged into a number of layers, with connections between the nodes of adjacent layers. The description herein generally applies to a feed-forward multilayer neural network, but similar structures and principles are used in convolutional neural networks, recurrent neural networks, graph neural networks, and recursive neural networks, for example.

Input values are introduced to the first layer of the neural network (the input layer), traverse some number of hidden layers, and then traverse an output layer that provides output values. A neural network may be a fully-connected network, in that nodes of each layer aside from the input layer receive input from all nodes in the previous layer. But partial connectivity between layers is also possible.

Connections between nodes represent paths through which intermediate values flow, and are each associated with a respective weight that is applied to the respective intermediate value. Each node performs an operation on its received values and their associated weights (e.g., values between 0 and 1, inclusive) to produce an output value. In some cases this operation may involve a dot-product sum of the products of each input value and associated weight. An activation function (e.g., a sigmoid, tan h or ReLU function) may be applied to the result of the dot-product sum to produce a scaled output value. Other operations are possible

Training a neural network usually involves providing the neural network with some form of supervisory training data, namely sets of input values and desired, or ground truth, output values. The training process involves applying the input values from such a set to the neural network and producing associated output values. A loss function is used to evaluate the error between the produced output values and the ground truth output values. This loss function may be a sum of differences, mean squared error, or some other metric. In some cases, error values are determined for all of the sets of input values, and the error function involves calculating an aggregate (e.g., an average) of these values.

Once the error is determined, the weights on the connections are updated in an attempt to reduce the error. In simple terms, this update process should reward “good” weights and penalize “bad” weights. Thus, the updating should distribute the “blame” for the error through the neural network in a fashion that results in a lower error for future iterations of the training data.

The training process continues applying the training data to the neural network until the weights converge. Convergence occurs when the error is less than a threshold value or the change in the error is sufficiently small between consecutive iterations of training. At this point, the neural network is said to be “trained” and can be applied to new sets of input values in order to predict output values that are unknown.

Most training techniques for the neural network make use of some form of backpropagation. Backpropagation distributes the error one layer at a time, from the output layer, through the hidden layers and to the input layer. Thus, the weights of the connections between the last hidden layer and the output layer are updated first, the weights of the connections between second-to-last hidden layer and last hidden layer are updated second, and so on. This updating can be based on a partial derivative of the activation function for each node and that node's connectivity to other nodes. Backpropagation completes when all weights have been updated.

In some cases, various hyperparameters can be used to adjust the learning of the neural network. For example, constant biases can be applied to the dot-product sums on a per layer basis. Further, a multiplicative learning rate, or gain, could be applied when weights are updated. Other possibilities exist.

Once trained, the neural network can be given new input values and produce corresponding output values that reflect what the neural network has learned by way of training. These output values may be predictions or classifications of the input values.

While the discussion above assumes supervised training, training processes can also be unsupervised. For instance, given a corpus of text documents, a neural network can learn mappings from documents to real-valued vectors in such a way that resulting vectors are similar for documents with similar content. This can be achieved using, for example, auto-encoders that reconstruct the original vector from a smaller representation with reconstruction error as a cost function. This process creates meaningful representations that can be used for clustering.

### VIII. GRAPH NEURAL NETWORKS FOR ANOMALY DETECTION

With the increasing use of graphs to represent data, such as computer networks, social networks, knowledge graphs, or even molecules, it has become important to understand the structure and properties of these objects. In that domain, graph neural networks (GNNs) show promising results in embedding the nodes of the graph with meaningful features. The power of such models come from their ability to learn the structure of the graph through a message-passing algorithm, while being invariant through re-ordering of the nodes, an essential property of graphs.

Anomaly detection refers to the problem of finding the samples in a dataset that are out of the ordinary, or finding an observation that differs so much from other observations as to arouse suspicion that it was generated by a different mechanism. The problem itself is ill-posed, as the definition of what constitutes an anomaly (or an outlier) is vague and often depends heavily on the application domain. As such, it is a challenging task to solve, and is made even more daunting due to the assumption that anomalies are extremely rare in practice and labeled data samples of anomalies are effectively non-existent. Nevertheless, anomaly detection is an important task that has been studied extensively and has applications in many areas such as healthcare, finance, and cybersecurity.

The embodiments herein detect anomalies in static graph-structured datasets where labeled anomalous samples are not given. In particular, the anomalous nodes of an input graph are identified. These are the nodes that differ significantly from the majority of remaining nodes in the graph, both in terms of features and in terms of their relations to other nodes. In this section, it is shown how GNNs can be used to create a model using graphs that is able to make anomalies within nodes of the graphs easier to detect. Being able to accurately find anomalies would help in solving many practical network problems, such as identifying misconfigurations, performance inefficiencies, security flaws, evidence of hacking, and so on. These techniques may also go beyond the examples explicitly provided herein to be able to detect spammers or bots on a social network, weak links in electrical networks, outliers in groups of people, etc. Moreover, having a good anomaly detection algorithm for graphs could be useful in improving other graph-based problems, such as clustering or classifying.

Graph-based problems are usually difficult to study due to their inherent dependence between elements. This dependence complicates the use of supervised methods, since the representation of the nodes always depend on the representation of all the other nodes, and it may be impossible to independently split the dataset. To avoid such issues, graph models usually organize the nodes into different groups and optimize the representation on one group of nodes, while assuming that this extends to the other groups. Randomly separating nodes into groups would ideally not affect the overall efficiency of the algorithm. However, this approach assumes that the property to be understood is well balanced over all the nodes and that this property can be observed on any subset of the graph. Thus, this approach fails when studying anomalies since, by definition, they are rare and unlikely to be observed.

Another approach to anomaly detection problems is to learn the distribution of the nodes. By taking a random sample from the dataset, it is likely that the number of anomalies will be negligible; hence, by learning the distribution of this sample, one can expect to approximate well the overall distribution of the dataset. When this approximation is computed, the likelihood of each element can be obtained, and the ones with lowest likelihood are classified as anomalies.

The embodiments herein provide two self-supervised models referred to as Anomaly GNNs: HideGNN and MaskGNN. These methods are based on recreating the features of the nodes, either by hiding specific features, or by putting a mask on random features. These two methods combine GNNs with techniques from Natural Language Processing (NLP). The power of these methods comes from their ability to reproduce the original features of the nodes of the graph that corresponds to their expected values. By using these reproduced features or by comparing them to the original ones, anomalies arise as nodes with unexpected attributes.

Put another way, given that anomalies are rare by definition, it is assumed that there are not enough examples in the input data to learn what an anomalous node looks like. Thus, the model tries to learn a general representation of the nodes by learning the characteristics of “normal” nodes. Any node in the graph that falls sufficiently far from this measure of normalcy will be classified as an anomaly. To learn the proper embedding function, self-supervised learning techniques are used. At every step of the algorithm, a feature of the node is hidden or masked. The model guesses the missing information. The assumption is that if the model gets good at this guessing, it will learn how to detect “normal” nodes. As a result, any nodes that are not considered to be “normal” will be classified as anomalous.

Note that although unsupervised learning is used to explain the embodiments, herein, aspects of supervised learning may be incorporated as well. For instance, some attributes may be labeled with an indication of whether they are indicative of normality or an anomaly, and the learning procedures may take these indications into account.

### A. Definitions

Consider a graph G=(V, E), where V is the set of nodes in the graph and E is the set of edges between pairs of nodes. In the examples here, only graphs with unweighted and undirected edges are considered for sake of simplicity. But these techniques can be applied to graphs with weighted and/or directed edges.

It is assumed that there is a feature function F(v)=(F(v)₁, . . . , F(v)_{ƒ})∈ [symbol] ^{ƒ} for all v∈V, where ƒ is the size of the feature space. Here, the features are assumed to be projections of the attributes of the nodes into the feature space. The number of attributes may vary from node to node. Notably, the database schema of the CMDB may define different types of nodes each with a potentially different set of attributes. In some of the examples below, the number of attributes per node is assumed to be ƒ for purposes of illustration. Nonetheless, the magnitude off may exceed the number of attributes when some attributes are projected into multiple dimensions (see below for more detail on projections).

An embedding function ε(⋅; θ) is defined based on some attributes θ, and creates the features of the nodes: ε(ν; θ)∈ [symbol] ^{ƒ}. The embedding can be thought of as a projection of the attributes of one or more nodes (represented as θ) into the f-dimensional feature space. In some embodiments, θ could be considered to be a more general set of parameters. Then, the following quantity can be optimized:

$${min}_{θ} \{ {\sum }_{v ∈ V} {\vert ε ( v ; θ ) - F ( v ) \vert}^{2} \}$$

Thus, the function ∈ depends on G and F, and can be defined using GNNs. Particularly, a GNN is a specific type of neural network uses a message-passing algorithm between the nodes of the graph to compute embeddings. It is assumed that there is an initial feature function X₀:V [symbol] ^{ƒ}^{ₒ}. In practice, X₀ may be set to a naïve projection of the attributes into feature space, with each attribute value mapping to a particular dimension of the feature space.

For example, since the feature space is real numbers, attributes that are integers or real numbers can be used directly or by way of a mathematical function on their values. Booleans may be transformed from values of “false” and “true” to 0's and 1's, respectively to ease embedding. Similarly, enumerated values may be transformed into numerical values (e.g., an enumerated attribute with four possible values may have these values transformed to 0, 1, 2, and 3, respectively. For text strings, an embedding that captures the semantic meaning of the words or phrases therein may be used. Thus, deep-learning-based semantic embedding techniques, such as word vectors, paragraph vectors, or bidirectional encoder representations from transformers (BERT) may be used to map these words or phrases into multiple dimensions. If a given node is missing an attribute, its projection could be set to an arbitrary value, such as 0. Thus, a wide variety of initial feature functions are possible.

A GNN with k layers iteratively creates a sequence of k embeddings X₁, . . . Xₖ for each node v such that:

[symbol]

(v)=UPDATE [symbol] (AGGREGATE [symbol] ( [symbol] (v),{ [symbol] (u):{u,v}∈E}))

The embeddings for a given node v takes into account the attributes of node v as well as its connectivity to neighboring nodes and the attributes of the neighboring nodes. The embeddings evolve into a form that can be used to predict when nodes are anomalous.

The AGGREGATE function uses the previous embeddings of the node v and its neighbors u and combines them. Once this combination is computed, the UPDATE function modifies the output of the AGGREGATE function and uses it to update the node embeddings. Many definitions are possible for these two functions but the most common ones are summing the neighbor's features, concatenating them with the original node's feature, or sub-sampling the neighborhoods.

Compared to other machine learning problems, having GNNs with too many layers is usually an issue as they tend to reduce the role of X₀. Thus, the embodiments herein use GNNs with two layers. But more or fewer layers can be used. Further, in these embodiments, the AGGREGATE function is defined as the sum of the neighbors multiplied by a matrix of weights. But other possible functions exist, such as weighted sums, set pooling, or neighborhood attention. The matrix of weights has a size [symbol] × [symbol] when current node embedding is not used or [symbol] × [symbol] when concatenating.

The UPDATE function is generally a non-linear function, for example a ReLU activation function. But for the last layer of the GNN, the UPDATE function is replaced by an identity function to allow negative values.

Putting this together, the GNN is defined to produce the embeddings as follows:

$${X}_{2} ( v ) = {X}_{1} ( v ) \cdot {W}_{2}^{c} + ( {\sum }_{\{ u , v \} ∈ E} {X}_{1} ( u ) ) \cdot {W}_{2} \\ {X}_{1} ( v ) = σ ( {X}_{0} ( v ) \cdot {W}_{1}^{c} + ( {\sum }_{\{ u , v \} ∈ E} {X}_{0} ( u ) ) \cdot {W}_{1} )$$

Where σ(x)=max(0, x), i.e., the ReLU function. The parameters of the GNN are the entries of W₁, W₁^{c}, W₂ and W₂^{c}, where W₁^{c}=0 and W₂^{c}=0 when not using concatenation.

As noted, the embeddings map the attributes of nodes into the ƒ-dimensional feature space. Practically speaking, these attributes may take on various types, such as integers, real numbers, Booleans, arbitrary enumerated values, and text strings, as just some examples. Thus, the embedding function ε(⋅;θ) may require more or less effort to pre-process each of these types.

Further, when there are a large number of attributes per node (e.g., 10 or more, 25 or more, or 50 or more), various techniques may be used to identify which attributes are the most “important” to consider when attempting to detect anomalies. These may include the attributes that contribute the most to the variability in attribute values between nodes, and could be identified by way of principle component analysis (PCA), for example.

B. The HideGNN Model

The HideGNN model uses a set of ƒ GNNs. Each of them will take F as input, where exactly one feature is hidden, and will use it to reproduce the hidden feature. The ƒ GNNs are denoted as X⁽¹⁾, X⁽²⁾, . . . , X^{(ƒ)}. For each 1≤i≤ƒ, X⁽ⁱ⁾ takes as input X₀⁽ⁱ⁾=F⁽⁻ⁱ⁾, where:

F⁽⁻ⁱ⁾(v)=(F(v)₁,F(v)₂, . . . ,F(v)ᵢ₋₁,F(v)ᵢ₊₁, . . . F(v)_{ƒ})

Thus, F⁽⁻ⁱ⁾ has all the original features of the graph except the ith, which is removed. The ith loss function is then defined to be the L2 norm between the prediction of the network for the hidden feature and the real value of the hidden feature:

$${L}_{i} ( {X}^{( i )} ) = {‖ {X}_{2}^{( i )} - {F ( \cdot )}_{f} ‖}_{2}^{2} = {\sum }_{v ∈ V} {\vert {X}_{2}^{( i )} ( v ) - {F ( v )}_{i} \vert}^{2}$$

Once every GNN is defined, the general embedding is set as the concatenation of the embeddings given by the different GNNs, and the general loss function is defined as the sum of all the previous loss functions. In other words:

$${ε}_{hide} ( v ; θ ) = ( {X}_{2}^{( 1 )} ( v ) , {X}_{2}^{( 2 )} ( v ) , … , {X}_{2}^{( f )} ( v ) ) \\ L ( {ε}_{hide} ) = {\sum }_{1 \leq i \leq f} {L}_{i} ( {X}^{( i )} )$$

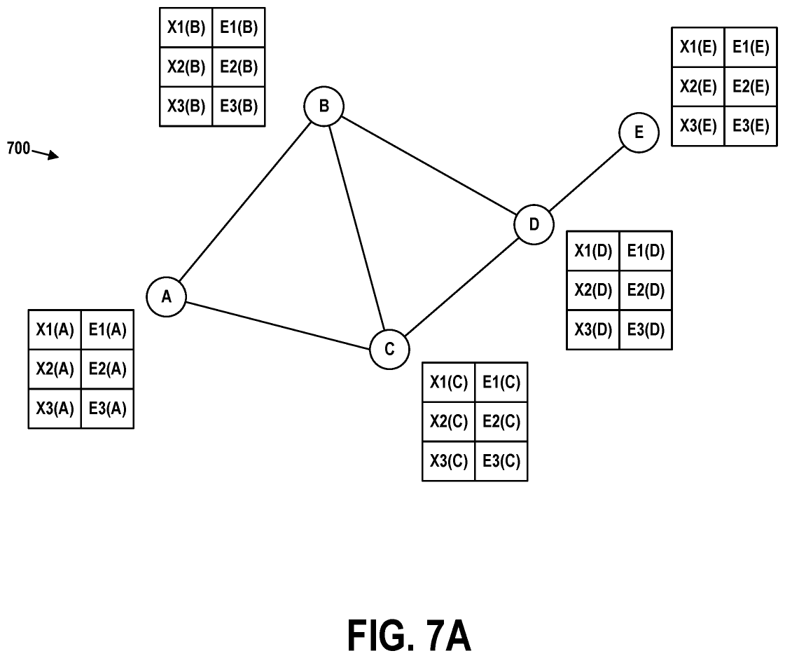

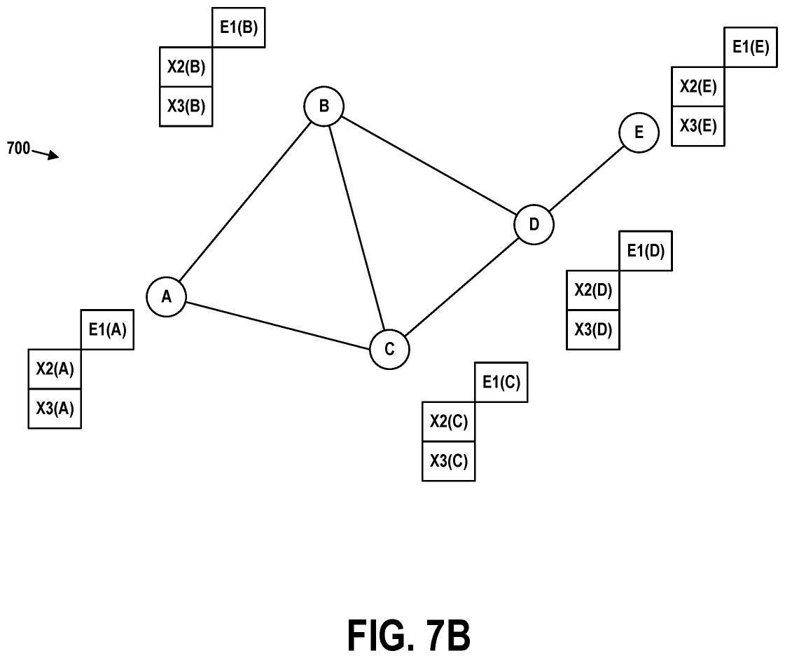

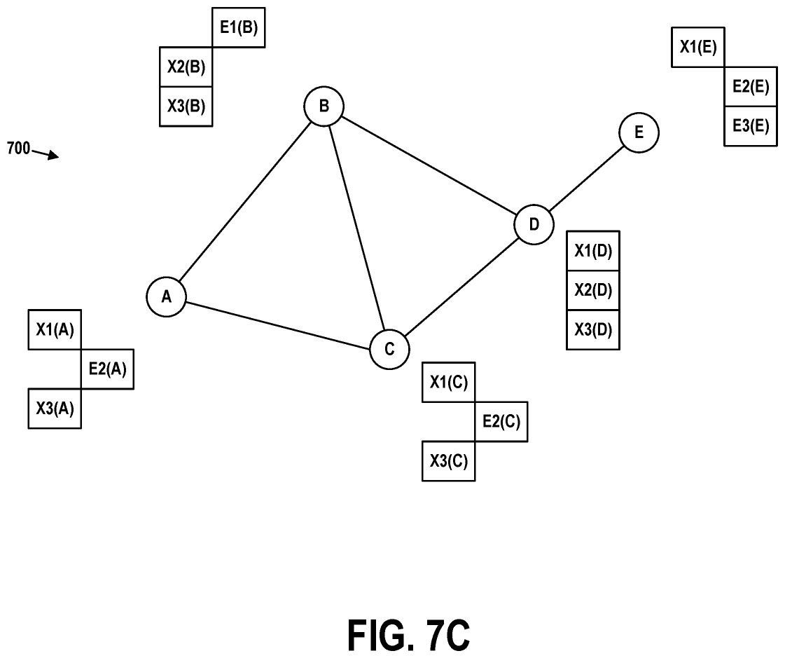

The hiding process is depicted in FIGS. 7A and 7B. FIG. 7A depicts a graph 700 consisting of 5 nodes, A, B, C, D, and E. Each node has a set of three attributes. For example, node A has attributes X1(A), X2(A), and X3(A), and node B has attributes X1(B), X2(B), and X3(B). The attributes for each node are embedded into a three-dimensional feature space. For example, node A is embedded as {E1(A), E2(A), E3(A)}, and node B is embedded as {E1(B), E2(B), E3(B)}. As noted, the number of dimensions in the feature space can be different from the number of attributes of the node. Graph 700 is a baseline with no hiding.

The HideGNN model takes a graph in which the embeddings have been determined, such as graph 700, and repeatedly hides an attribute and then uses the remaining attributes to embed the nodes into a one-dimensional feature space trained to represent the hidden attribute. FIG. 7B depicts a step of this process for graph 700. In FIG. 7B, the first attribute of each node is hidden, and then the second and third are used to derive (guess) an embedding for the hidden attribute. This hiding and projecting process continues for all attributes.

An anomaly is flagged when the embeddings derived from the hiding process deviates from the “known” embeddings by more than a pre-determined amount. A mean squared distance calculation or Euclidean distance calculation may be used to determine the deviation. The pre-determined amount may be, for example, based on a distribution of distances calculated over the “known” embeddings. Thus, in some embodiments, if the deviation is more than two or three standard deviations from the mean of this distribution, the node may be determined to be anomalous.

Since this model uses multiple GNNs, it can be computationally expensive to train. Moreover, due to the high number of parameters, it is also sensitive to over-fitting. Finally, this model lacks the ability to train from what it sees—since every GNN hides a single feature, it is not able to observe this hidden feature and infer from it. On the other hand, this model can be helpful if there are a small number of attributes (e.g., 1, 2, or 3) that are known to be more indicative of an anomalous node than others. Then, just these attributes can be hidden and the number of GNNs to apply can be similarly limited.

C. MaskGNN Model

The MaskGNN model is a faster model that uses a single GNN. It can observe all entries of the graph, while trying to reproduce masked features. During the training phase, it masks some of the features of its input and focuses on specifically reproducing these ones, giving a non-trivial function as output. Consider a random mask M:V [symbol] {0,1}^{ƒ}. The masked features are defined as:

$${{F}_{M} ( v )}_{i} = \{ \begin{matrix}{F ( v )}_{i} & if {M ( v )}_{i} = 0 \\ {m}_{v} & if {M ( v )}_{i} = 1\end{matrix}$$

In some embodiments, mᵥ, the masked value, is set to 0. Thus, F_{M} corresponds to F where all entries of a 1 in the mask M have been replaced by mᵥ.

The MaskGNN is defined to be the GNN X taking X₀=F_{M} as input and with the loss function:

$$L ( {ε}_{mask} ) = {‖ {( {X}_{2} - F )}_{( 1 - M )} ‖}_{2}^{2} = {\sum }_{v ∈ V} {\sum }_{1 \leq i \leq f} {M ( v )}_{i} \cdot {\vert {{X}_{2} ( v )}_{i} - {F ( v )}_{i} \vert}^{2}$$

In other words, the goal is to optimize the outputs of εₘₐₛₖ based only on the set of unmasked values (i.e., where M(v)ᵢ=1). By going over multiple random masks, M(v)ᵢ, this algorithm learns a general representation of F.

The masking process is depicted in FIGS. 7A and 7C. As noted above, FIG. 7A depicts graph 700 with each node having a set of three attributes with a known embedding into three-dimensional feature space. FIG. 7C depicts graph 700 with some random attributes and embeddings masked.

To that point, the MaskGNN model takes a graph in which the embeddings have been determined, such as graph 700, and randomly masks various attributes and then uses the remaining attributes to embed the nodes into a feature space trained to represent the masked attributes. FIG. 7C depicts a step of this process. For example, the second attribute of node A is masked, and then the first and third, as well as other attributes of the graph, are used to derive (guess) an embedding for the masked attribute. This masking and projecting process iterates some number of times, until a three-dimensional embedding is obtained. The iterations may be complete when the embedding stabilizes in the feature space, e.g., when the Euclidean distance between sequential iterations of embeddings is less than a threshold value. Or, the iterations may complete once a threshold number of iterations have been performed (e.g., 100 or 1000), and the loss function has similarly plateaued. But other stopping conditions could be used.

### IX. EXPERIMENTAL RESULTS

When considering anomalies in a graph, there does not seem to exist a unified definition. Indeed, anomalies can come in different forms. Some of these may be feature-based, graph-based, or combinations thereof, and are defined below.

Feature-based anomalies (type 1 anomalies). By only considering the feature function F, one can observe and study anomalies. Indeed, it is very likely that this function already exhibits feature anomalies, such as nodes with large features, or unexpected combinations of features.

Graph-based anomalies (type 2 anomalies). By only considering the graph structure described in G, one can observe and study anomalies. Indeed, nodes can show anomalous behavior by having large or small degrees, but also by finding themselves outside or in-between clusters of nodes.

Combined anomalies (type 3 anomalies). This type of anomaly is the most difficult one to observe and comes from combining the graph structure and the node features. For example, a node could find itself in a natural graph community, while having features from another community. Thus, the features of the node itself might not be anomalous and its neighboring nodes might not be anomalous, but the combination of the particular node within the particular neighborhood might be anomalous.

In order to validate the efficacy of using GNNs to identify anomalies, the algorithms above were tested against two synthetic datasets. Use of synthetic datasets allowed for control over the number of anomalous nodes, their connectivity, and their attributes. The first synthetic dataset, called the “basic” dataset, is able to test for the first two types of anomalies. The second synthetic dataset, called the “group” dataset, is more useful in testing the third type of anomalies. These two datasets are described below and are mainly generated using stochastic block model techniques.

A. Basic Dataset

The first synthetic dataset (the “basic” dataset) involves a set of nodes V divided into two subsets, V_{N} and V_{A}. Subset V_{N} represents normal nodes and subset V_{A} represents anomalous nodes. It is expected that |V_{A}|«|V_{N}|. Edges between these nodes are created using a stochastic block model such that every edge is defined independently with probabilities given by:

$$P ( \{ u , v \} is an edge ) = \{ \begin{matrix}{p}_{N} & if u , v ∈ {V}_{N} \\ {p}_{A} & if u , v ∈ {V}_{A} \\ {p}_{N , A} & otherwise\end{matrix}$$

While p_{N}, p_{A}, and p_{N,A} could take on any value between 0 and 1 inclusive, setting p_{N}=p_{A}=p_{N,A} results in anomalous nodes being differentiated from normal nodes only by their attributes and not based on their connectivity (making them type 1 anomalies). Once a synthetic graph is created, the attributes of the nodes are defined to be:
N(0,1) if v∈V_{N}

And:
N(μ_{A},α_{A}) if v∈V_{A}

Where N(a, b) is a function that returns a random value from a Normal distribution with mean a and standard deviation b. Thus, the values of μ_{A} and σ_{A} are the mean and standard deviation for anomalous nodes. By setting μ_{A}=0 and σ_{A}=1, anomalous nodes are only defined by their connectivity and not their attributes (making them type 2 anomalies).

B. Group Dataset

The second synthetic dataset (the “group” dataset) involves a set of nodes V divided into two subsets, V₁ and V₂ that are approximately the same size. A set of anomalous nodes V_{A} is defined such that |V_{A}|«|V| and |V_{A}∩V₁|≅|V_{A}∩V₂|. Edges between these nodes are created using a stochastic block model such that every edge is defined independently with probabilities given by:

$$P ( \{ u , v \} is an edge ) = \{ \begin{matrix}{p}_{in} & if u , v ∈ {V}_{1} or u , v ∈ {V}_{2} \\ {p}_{out} & otherwise\end{matrix}$$

Where pₒᵤₜ and pₒᵤₜ can take on any value between 0 and 1 inclusive. This process creates two distinct groups of nodes so long as |V|(pᵢₙ−pₒᵤₜ)²>²(pᵢₙ+pₒᵤₜ). Once a synthetic graph is created, the attributes of the nodes are defined to be:
N(0,1) if v∈V₁\V_{A}^{c} or v∈V_{A}∩V₂

And:
N(μ′, σ′) otherwise

This makes most nodes of V₁ have attributes with mean 0 and standard deviation 1, and most nodes of V₂ have attributes with mean μ′ and standard deviation σ′. However, a few nodes in V₁ have the features of V₂ and vice-versa.

C. Experiments

The two models, HideGNN and MaskGNN, are meant to reproduce the features of the nodes of the graph and. in that sense, were not originally created as standalone anomaly detection algorithms. For anomaly detection, HideGNN and MaskGNN are used as pre-training and their outputs are then used as inputs for other standard algorithms. The efficiency of the standard algorithms is compared before and after using HideGNN and MaskGNN pre-training.

For these experiments, HideGNN and MaskGNN models are used as pre-training to derive more information about the nodes. For each algorithm, four experiments were carried out. The first experiment uses the standard algorithm directly on the dataset (original). The second experiment replaces the original features of the dataset by the ones obtained as output of HideGNN and MaskGNN, and applies the compared algorithm to this new dataset (reproduced). The third experiment combines the previous two methods and adds to the original dataset the reproduced features given by HideGNN and MaskGNN. It then applies the compared algorithm to this new dataset, where the number of node features is doubled (combined). The fourth experiment considers only the reproduced features and applies the standard algorithm (difference).

TABLE 1

| | Disney | Books | Enron |
|---|---|---|---|
| Nodes | 124 | 1418 | 13533 |
| Edges | 335 | 3695 | 176987 |
| Features | 32 | 21 | 18 |
| Anomalies | 6 | 28 | 5 |

To test the efficacy of these models for anomaly detection, three existing datasets entitled Disney, Books, and Enron, were used. The statistics of these datasets can be found in Table 1. The common metric used was area under the curve (AUC).

AUC is defined as the area under a curve that plots the FP rate on the x-axis versus the TP rate on the y-axis, where TP is a count of true positives and FP is a count of false positives. The FP rate is given as FP/(FP+TN), while the TP rate is given as TP/(TP+FN), where TN is a count of true negatives and FN is a count of false negatives. These plots are from 0 to 1 on each axis. The closer the AUC is to 1, the more distinct the true positives are from the true negatives. Thus, the higher the AUC score, the more accurate the anomaly detection.

Each of the HideGNN and MaskGNN models were used with four existing anomaly detection algorithms: one class support vector machine (OCSVM), maximum entropy generators (MEG), multi-scale anomaly detection on attributed networks (MADAN), and partial anomaly identification and clustering in attributed networks (PAICAN). The results are compared to using these existing algorithms on their own, without the embodiments herein. Note that the results provided herein are preliminary, as further tuning and experimenting are expected to provide improvements.

TABLE 2

| Model | Disney | Books | Enron |
|---|---|---|---|
| OCSVM | 0.390 | 0.359 | 0.557 |
| HideGNN + OCSVM | 0.468 | 0.496 | 0.503 |
| MaskGNN + OCSVM | 0.438 | 0.548 | 0.589 |
| MEG | 0.520 | 0.615 | 0.512 |
| HideGNN + MEG | 0.592 | 0.676 | 0.838 |
| MaskGNN + MEG | 0.633 | 0.556 | 0.518 |
| MADAN | [symbol] | 0.530 | 0.674 |
| HideGNN + MADAN | 0.618 | 0.607 | 0.583 |
| MaskGNN + MADAN | 0.668 | 0.622 | 0.824 |
| PAICAN | 0.637 | 0.645 | 0.436 |
| HideGNN + PAICAN | 0.648 | 0.624 | 0.740 |
| MaskGNN + PAICAN | 0.626 | 0.682 | 0.700 |

The results are shown in Table 2. The best score for each group is shown in bold. From this table, it can be observed that using the embodiments herein improves the performance of the existing algorithms in most cases. For example, the OCSVM, MEG, and PAICAN algorithm performance was improved by being combined with HideGNN or MaskGNN pre-training in every trial. For the Disney dataset, the existing MADAN algorithm has the best scores among the three MADAN-based approaches in its group (shown in bold italics). This may be due to the small size of the Disney dataset and the use of neural-network-based models that typically benefit from larger datasets.

From this table, it can also be observed that HideGNN performs usually better than MaskGNN. This higher accuracy might however be counter-balanced by the fact that HideGNN is slower to train and uses more memory. MaskGNN also has more parameters that can be tuned (e.g., how long to train using a mask before changing it, and how many masks used in training). A deeper parameter optimization might bring MaskGNN to the level of HideGNN. In that sense, the advantages of one model are the drawbacks of the other: HideGNN is longer to train, but needs less parameter tuning, whereas MaskGNN is faster to train and takes less memory, but requires finer parameter tuning.

Thus, the embodiments herein create feature embeddings that can more clearly represent the differences between anomalous and non-anomalous nodes. The performance of existing anomaly detection algorithms can be improved by executing on this representation instead of the raw graph data and/or raw attribute data.

### X. PRACTICAL APPLICATIONS TO CMDB DATA

These embodiments can be applied to CMDB data in numerous ways. For instance, certain groups of configuration items with relationships that form a graph can be considered. Such a group might be defined in the CMDB as a service (e.g., load balancer, mail servers, and mail databases), may be manually specified, or may be defined in some other fashion. Regardless, once a group of configuration items amenable to graph representation is identified, the GNN techniques described herein can be used, possibly in conjunction with existing anomaly detection algorithms, to identify anomalies in the group.

Further, these techniques may be able to identify how anomalous a particular configuration item is likely to be by way of a numeric score. The score could be based on a difference (e.g., Euclidian distance) between an expected projection of the configuration item into the feature space and the actual projection.

For instance, suppose that a service defines a group of related configuration items. The embodiments described herein may be configured to be performed periodically, from time to time, or based on a manual triggering. As an example, the anomaly detection techniques herein may be executed once a day to detect anomalies amongst these configuration items. If any are detected, they may be presented to a user by way of an email or graphical user interface screen, such as a dashboard. If multiple anomalies are detected, they can be listed in reverse order of their numeric score, so that the configuration items that are likely to be the most anomalous are shown first.

Alternatively or additionally, when a new configuration item is added to the CMDB, the techniques herein may be automatically used to determine whether that configuration item conforms to a standard set of attributes. This might be expected to be the case because devices or software of the same type may be configured similarly. Executing anomaly detection techniques when a configuration item is placed into service may facilitate rapid determination of whether the configuration item is properly configured.

In another example, a user may be in charge of the operation of a number of related configuration items. Every so often, the user may manually trigger the embodiments herein to execute on these configuration items in order to identify any that are behaving in an anomalous fashion.

The types of anomalies detectable can vary based on the types of attributes that are discoverable for different software and hardware components of the managed network. Some configuration items might only represent how these components are configured (e.g., IP addresses, TCP/UDP port numbers, application names that are executing, correspondent devices, etc.). Others may represent performance-related information, such as processor utilization, memory utilization, storage utilization, and so on.

It should be clear that the embodiments herein can be used in numerous ways, including in manners not involving CMDB data and/or not explicitly described above. Thus, these examples are not limiting.

### XI. EXAMPLE OPERATIONS

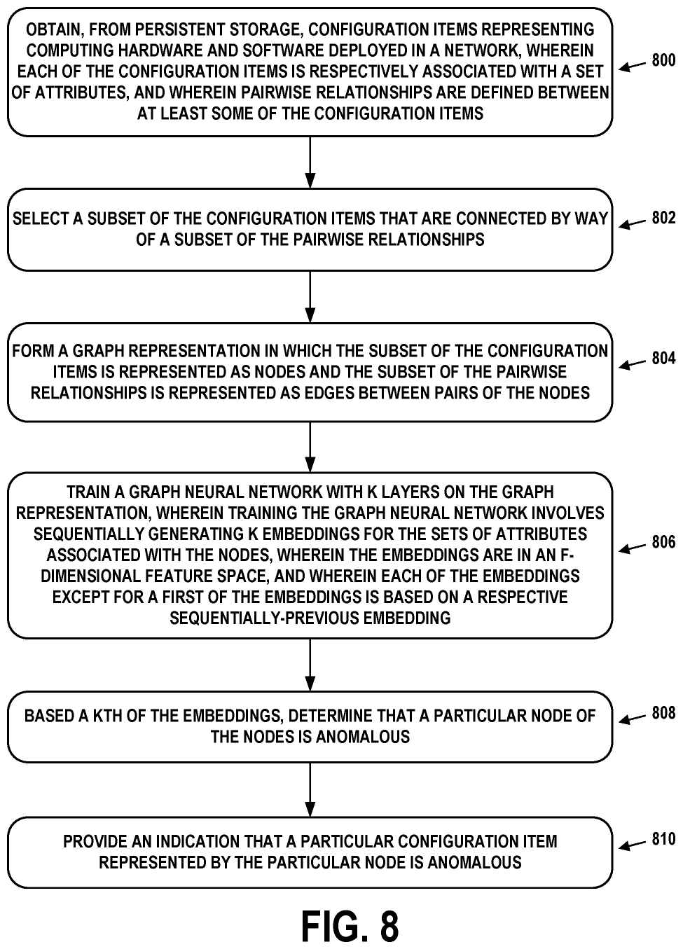

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

Block 800 may involve obtaining, from persistent storage, configuration items representing computing hardware and software deployed in a network, wherein each of the configuration items is respectively associated with a set of attributes, and wherein pairwise relationships are defined between at least some of the configuration items.

Block 802 may involve selecting a subset of the configuration items that are connected by way of a subset of the pairwise relationships.

Block 804 may involve forming a graph representation in which the subset of the configuration items is represented as nodes and the subset of the pairwise relationships is represented as edges between pairs of the nodes.

Block 806 may involve training a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding.

Block 808 may involve, based a kth of the embeddings, determining that a particular node of the nodes is anomalous.

Block 810 may involve providing an indication that a particular configuration item represented by the particular node is anomalous.

In some embodiments, the pairwise relationships include at least some that indicate that one configuration item runs on, is hosted by, depends on, or runs on another configuration item.

In some embodiments, the subset of the configuration items is selected based on user input.

In some embodiments, the subset of the configuration items is defined to be related to a service deployed on the network.

In some embodiments, the first of the embeddings is a projection of the sets of attributes into the f-dimensional feature space.

In some embodiments, an embedding for a specific node of the nodes is based on attributes of the specific node and attributes of one or more neighboring nodes that connect to the specific node, wherein the embedding is not in the first of the embeddings, and wherein the one or more neighboring nodes are one edge-distance away from the specific node.

In some embodiments, the embedding of the specific node is based on multiplication of the attributes of the specific node by a first matrix of weights and multiplication of the attributes of the one or more neighboring nodes by a second matrix of weights.

In some embodiments, training the graph neural network on the graph representation comprises training f graph neural networks on the graph representation, wherein each of the f graph neural networks specifies a different feature of the f features as a respective hidden feature, and wherein each of the f graph neural networks uses a respective loss function that is based on a difference between the kth of the embeddings and an embedding with the respective hidden feature. In some embodiments, a general loss function across the f graph neural networks is based on a sum of the respective loss functions.

In some embodiments, training the graph neural network on the graph representation comprises training the graph neural network in multiple iterations, wherein each iteration of the training involves masking out one random feature per node and applying a loss function based only on unmasked features.

In some embodiments, determining that the particular node is anomalous comprises executing an existing anomaly detection algorithm on the kth of the embeddings.

In some embodiments, providing the indication that the particular configuration item represented by the particular node is anomalous comprises providing, in response to a user request and to a client device, a representation of a graphical user interface indicating that the particular configuration item is potentially anomalous along with a list of one or more other instances of the configuration items that are also indicated as potentially anomalous.

In some embodiments, k is 2 or 3.

### XII. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing configuration items representing computing hardware and software deployed in a network, wherein each of the configuration items is respectively associated with a set of attributes, and wherein pairwise relationships are defined between at least some of the configuration items; and
one or more processors configured to:
select a subset of the configuration items that are connected by way of a subset of the pairwise relationships;
form a graph representation in which the subset of the configuration items is represented as nodes and the subset of the pairwise relationships is represented as edges between pairs of the nodes;
train a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding;
based a kth of the embeddings, determine that a particular node of the nodes is anomalous; and
provide an indication that a particular configuration item represented by the particular node is anomalous.

2. The system of claim 1, wherein the pairwise relationships include at least some that indicate that one configuration item runs on, is hosted by, depends on, or runs on another configuration item.

3. The system of claim 1, wherein the subset of the configuration items is selected based on user input.

4. The system of claim 1, wherein the subset of the configuration items is defined to be related to a service deployed on the network.

5. The system of claim 1, wherein the first of the embeddings is a projection of the sets of attributes into the f-dimensional feature space.

6. The system of claim 1, wherein an embedding for a specific node of the nodes is based on attributes of the specific node and attributes of one or more neighboring nodes that connect to the specific node, wherein the embedding is not in the first of the embeddings, and wherein the one or more neighboring nodes are one edge-distance away from the specific node.

7. The system of claim 6, wherein the embedding of the specific node is based on multiplication of the attributes of the specific node by a first matrix of weights and multiplication of the attributes of the one or more neighboring nodes by a second matrix of weights.

8. The system of claim 1, wherein training the graph neural network on the graph representation comprises:
training f graph neural networks on the graph representation, wherein each of the f graph neural networks specifies a different feature of the f features as a respective hidden feature, and wherein each of the f graph neural networks uses a respective loss function that is based on a difference between the kth of the embeddings and an embedding with the respective hidden feature.

9. The system of claim 8, wherein a general loss function across the f graph neural networks is based on a sum of the respective loss functions.

10. The system of claim 1, wherein training the graph neural network on the graph representation comprises:
training the graph neural network in multiple iterations, wherein each iteration of the training involves masking out one random feature per node and applying a loss function based only on unmasked features.

11. The system of claim 1, wherein determining that the particular node is anomalous comprises:
executing an existing anomaly detection algorithm on the kth of the embeddings.

12. The system of claim 1, wherein providing the indication that the particular configuration item represented by the particular node is anomalous comprises:
providing, in response to a user request and to a client device, a representation of a graphical user interface indicating that the particular configuration item is potentially anomalous along with a list of one or more other instances of the configuration items that are also indicated as potentially anomalous.

13. The system of claim 1, wherein k is 2 or 3.

14. A computer-implemented method comprising:
obtaining, from persistent storage, configuration items representing computing hardware and software deployed in a network, wherein each of the configuration items is respectively associated with a set of attributes, and wherein pairwise relationships are defined between at least some of the configuration items;
selecting a subset of the configuration items that are connected by way of a subset of the pairwise relationships;
forming a graph representation in which the subset of the configuration items is represented as nodes and the subset of the pairwise relationships is represented as edges between pairs of the nodes;
training a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding;
based a kth of the embeddings, determining that a particular node of the nodes is anomalous; and
providing an indication that a particular configuration item represented by the particular node is anomalous.

15. The computer-implemented method of claim 14, wherein an embedding for a specific node of the nodes is based on attributes of the specific node and attributes of one or more neighboring nodes that connect to the specific node, wherein the embedding is not in the first of the embeddings, and wherein the one or more neighboring nodes are one edge-distance away from the specific node.

16. The computer-implemented method of claim 15, wherein the embedding of the specific node is based on multiplication of the attributes of the specific node by a first matrix of weights and multiplication of the attributes of the one or more neighboring nodes by a second matrix of weights.

17. The computer-implemented method of claim 14, wherein training the graph neural network on the graph representation comprises:
training f graph neural networks on the graph representation, wherein each of the f graph neural networks specifies a different feature of the f features as a respective hidden feature, and wherein each of the f graph neural networks uses a respective loss function that is based on a difference between the kth of the embeddings and an embedding with the respective hidden feature.

18. The computer-implemented method of claim 17, wherein a general loss function across the f graph neural networks is based on a sum of the respective loss functions.

19. The computer-implemented method of claim 14, wherein training the graph neural network on the graph representation comprises:
training the graph neural network in multiple iterations, wherein each iteration of the training involves masking out one random feature per node and applying a loss function based only on unmasked features.

20. An article of manufacture including a non-transitory computer-readable medium, having stored thereon program instructions that, upon execution by a computing system, cause the computing system to perform operations comprising:
obtaining, from persistent storage, configuration items representing computing hardware and software deployed in a network, wherein each of the configuration items is respectively associated with a set of attributes, and wherein pairwise relationships are defined between at least some of the configuration items
selecting a subset of the configuration items that are connected by way of a subset of the pairwise relationships;
forming a graph representation in which the subset of the configuration items is represented as nodes and the subset of the pairwise relationships is represented as edges between pairs of the nodes;
training a graph neural network with k layers on the graph representation, wherein training the graph neural network involves sequentially generating k embeddings for the sets of attributes associated with the nodes, wherein the embeddings are in an f-dimensional feature space, and wherein each of the embeddings except for a first of the embeddings is based on a respective sequentially-previous embedding;
based a kth of the embeddings, determining that a particular node of the nodes is anomalous; and
providing an indication that a particular configuration item represented by the particular node is anomalous.
